(19) United States
(12) Patent Application Publication
(10) Pub. No.: US 2026/0080066 A1
(43) Pub. Date: Mar. 19, 2026

(54) ELECTRONIC APPARATUS

(71) Applicant: KYOCERA Document Solutions Inc., Osaka (JP)

(72) Inventors: Tetsuya Matsusaka, Osaka (JP); Ho Ri, Osaka (JP)

(21) Appl. No.: 19/326,440

(22) Filed: Sep. 11, 2025

(30) Foreign Application Priority Data
Sep. 17, 2024 (JP) 2024-159756

(51) Int. Cl. G06F 21/57; G06F 9/4401

(52) U.S. Cl. CPC G06F 21/575; G06F 9/4405

(57) ABSTRACT

An electronic apparatus includes a bootloader and a firmware to be started by the bootloader. Further, the bootloader (a) determines whether a specific hardware module has been installed in the electronic apparatus or not when the electronic apparatus starts, and (b) if the specific hardware module has been installed, performs secure boot of the firmware with an argument that indicates secure boot setting, and if the specific hardware module has not been installed, performs normal boot of the firmware without the argument; and when the secure boot is performed, the firmware (a) on the basis of the argument, detects that the firmware is started under the secure boot, and (b) if the firmware detects that the firmware is started under the secure boot, performs a process to be performed in the secure boot.

### CROSS-REFERENCE TO RELATED APPLICATIONS

This application relates to and claims priority rights from Japanese Patent Application No. 2024-159756, filed on Sep. 17, 2024, the entire disclosures of which are hereby incorporated by reference herein.

### BACKGROUND

### 1. Field of the Present Disclosure

The present disclosure relates to an electronic apparatus.

### 2. Description of the Related Art

An information processing apparatus has a secure boot function, and in the secure boot function, performs a boot process of a firmware with a falsification detection process of the firmware.

An electronic apparatus is enabled to be equipped with a trusted platform module (TPM), and if the electronic apparatus is equipped with the TPM, the electronic apparatus is capable of secure boot with the TPM. If secure boot with the TPM should be performed, it is required to update a bootloader program. However, when the bootloader program is updated, in the middle of the update, the update may not be able to be restarted due to cutting off power supply and may fall into an inoperative status. Therefore, a small update frequency of the bootloader program is favorable.

### SUMMARY

An electronic apparatus according to an aspect of the present disclosure includes a bootloader and a firmware to be started by the bootloader. Further, the bootloader (a) determines whether a specific hardware module has been installed in the electronic apparatus or not when the electronic apparatus starts, and (b) if the specific hardware module has been installed, performs secure boot of the firmware with an argument that indicates secure boot setting, and if the specific hardware module has not been installed, performs normal boot of the firmware without the argument; and when the secure boot is performed, the firmware (a) on the basis of the argument, detects that the firmware is started under the secure boot, and (b) if the firmware detects that the firmware is started under the secure boot, performs a process to be performed in the secure boot.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates a configuration of an image forming apparatus according to an embodiment of the present disclosure; and

FIG. 2 shows a flowchart that explains a behavior of the image forming apparatus shown in FIG. 1.

### DETAILED DESCRIPTION

Hereinafter, an embodiment according to an aspect of the present disclosure will be explained with reference to drawings.

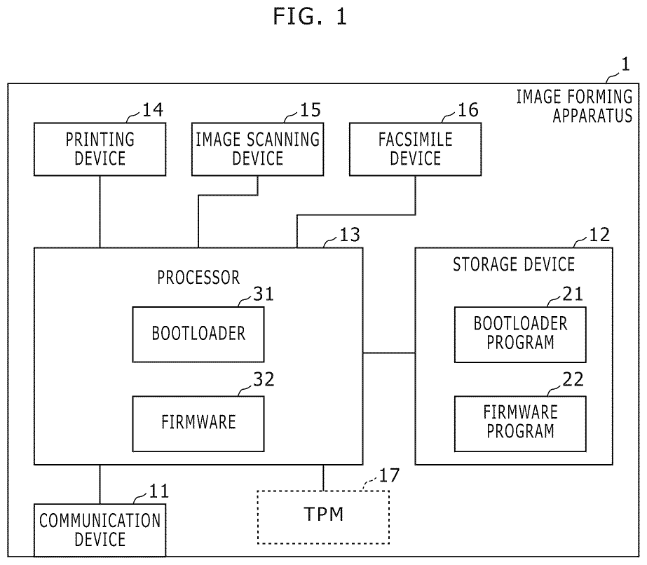

FIG. 1 shows a block diagram that indicates a configuration of an image forming apparatus according to an embodiment of the present disclosure. The image forming apparatus 1 shown in FIG. 1 is an apparatus such as multi function peripheral and is a sort of an electronic apparatus.

The image forming apparatus 1 includes a communication device 11, a storage device 12, a processor 13, a printing device 14, an image scanning device 15, a facsimile device 16 and the like. Further, the image forming apparatus 1 is enabled to be equipped with a TPM 17 (for example, an interface, a slot or the like for the TPM 17 has been installed). The processor 13 can access the TPM 17 through the interface, the slot or the like.

The communication device 11 is a device such as network interface and performs data communication in accordance with a predetermined protocol.

The storage device 12 is a non-volatile and rewritable storage device (flash memory or the like), and stores a bootloader program 21 and a firmware program 22. For example, the firmware program 22 includes programs of an operating system (kernel and the like) and an application program.

The processor 13 is a computer that includes a CPU (Central Processing Unit), a ROM (Read Only Memory), and a RAM (Random Access Memory), loads a program stored in the ROM or the storage device 12 to the RAM, and executes the program with the CPU and thereby acts as various processing units.

The printing device 14 prints an image based on print data received from an external device, an image scanned by the image scanning device 15, an image generated by the facsimile device 16, or the like. The image scanning device 15 optically scans a document image of a document and generates document image data of the document image. The facsimile device 16 generates and transmits a facsimile signal based on an image based on print data received from an external device, an image scanned by the image scanning device 15 or the like, and receives a facsimile signal from an external device and generates an image from the received facsimile signal.

The processor 13 executes the bootloader program 21 and thereby acts as a bootloader 31. Further, the processor 13 executes the firmware program 22 and thereby acts as a firmware 32. The firmware 32 is started by the bootloader 31 and includes an operating system and an application. The operating system includes a kernel, a filesystem and the like. The application controls an internal device such as the printing device 14, the image scanning device 15, or the facsimile device 16, for example.

The bootloader 31 (a) determines whether the TPM 17 as a specific hardware module has been installed in the image forming apparatus 1 or not when the image forming apparatus 1 starts, and (b) if the TPM 17 has been installed, performs secure boot of the firmware 32 with an argument that indicates secure boot setting, and if the TPM 17 has not been installed, performs normal boot (non-secure boot) of the firmware 32 without the argument.

Further, when the secure boot is performed, the firmware 32 (a) on the basis of the aforementioned argument, detects that the firmware 32 is started under the secure boot, and (b) if the firmware 32 detects that the firmware 32 is started under the secure boot, performs runtime integrity check.

Specifically, in an initial boot after the TPM 17 is installed to the image forming apparatus 1, the bootloader 31 performs the normal boot without the argument; and in the initial boot after the TPM 17 is installed to the image forming apparatus 1, the firmware 32 (a) initializes the TPM 17 and (b) restarts the image forming apparatus 1. Here, in the initialization of the TPM 17, authentication information (public encryption key, public encryption key digest or the like) used for the secure boot is written into the TPM 17. For example, a specific application (an init program in a root system (rootfs) or the like) writes the aforementioned authentication information into the TPM 17.

Further, in a second or later boot after the TPM 17 is installed to the image forming apparatus 1, the bootloader 31 performs the secure boot of the firmware 32 with the aforementioned argument using the TPM 17 (i.e. on the basis of the aforementioned public encryption key, public encryption key digest or the like). In the second or later boot after the TPM 17 is installed to the image forming apparatus 1, the firmware 32 (a) (for example, refers to procfs and thereby determines the aforementioned argument, and) on the basis of the argument, detects that the firmware 32 is started under the secure boot, and (b) if the firmware 32 detects that the firmware 32 is started under the secure boot, performs the runtime integrity check. For example, a kernel of an operating system in the firmware 32 initializes a driver of the runtime integrity check, and a specific application in the firmware 32 starts the runtime integrity check.

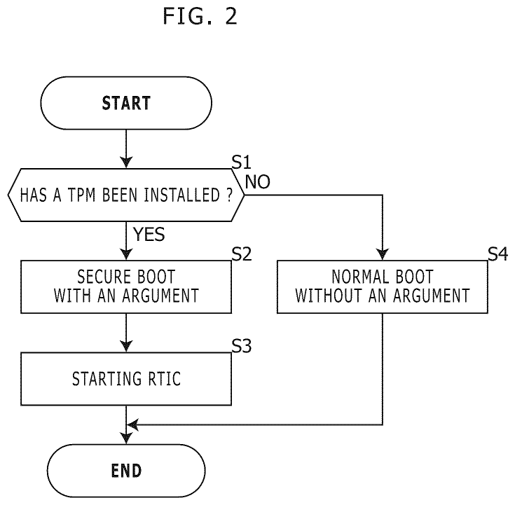

The following part explains a behavior of the aforementioned image forming apparatus 1. FIG. 2 shows a flowchart that explains a behavior of the image forming apparatus shown in FIG. 1.

When the image forming apparatus 1 starts, the bootloader program 21 is executed by the processor 13 and thereby the bootloader 31 starts. The bootloader 31 determines whether the TPM 17 has been installed or not (in Step S1).

If the TPM 17 has been installed, the bootloader 31 performs secure boot of the firmware 32 with an argument of secure boot setting (in Step S2), and the firmware 32 refers to the aforementioned argument and determines that the runtime integrity check (RTIC) should be performed and subsequently performs the RTIC (in Step S3).

Contrarily, if the TPM 17 has not been installed, the bootloader 31 performs normal boot of the firmware 32 without the argument of the secure boot setting (in Step S4). Here, the firmware 32 determines that the RTIC should not be performed because the aforementioned argument is not provided. Therefore, the firmware 32 does not refer to the TPM 17 in order to determine whether the secure boot should be performed or not.

As mentioned, in the aforementioned embodiment, the bootloader 31 (a) determines whether the TPM 17 has been installed in the image forming apparatus 1 or not when the image forming apparatus 1 starts, and (b) if the TPM 17 has been installed, performs secure boot of the firmware 32 with an argument that indicates secure boot setting, and if the TPM 17 has not been installed, performs normal boot of the firmware 32 without the argument. When the secure boot is performed, the firmware 32 (a) on the basis of the argument, detects that the firmware 32 is started under the secure boot, and (b) if the firmware 32 detects that the firmware is started under the secure boot, performs a process to be performed in the secure boot.

Consequently, without updating the bootloader program 21, the secure boot can be performed after the TPM 17 is installed. In addition, the firmware 32 detects the secure boot and can perform the process to be performed in the secure boot.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, in an initial boot after the aforementioned TPM 17 is installed, the firmware 32 may write data that indicates installation of the TPM 17 into a predetermined storage area of the storage device 12, and may determine whether the TPM 17 is installed or not (whether the secure boot should be performed or not) on the basis of whether the data is written in the predetermined storage area or not.

What is claimed is:

1. An electronic apparatus, comprising:
a bootloader; and
a firmware to be started by the bootloader;
wherein the bootloader (a) determines whether a specific hardware module has been installed in the electronic apparatus or not when the electronic apparatus starts, and (b) if the specific hardware module has been installed, performs secure boot of the firmware with an argument that indicates secure boot setting, and if the specific hardware module has not been installed, performs normal boot of the firmware without the argument; and
when the secure boot is performed, the firmware (a) on the basis of the argument, detects that the firmware is started under the secure boot, and (b) if the firmware detects that the firmware is started under the secure boot, performs a process to be performed in the secure boot.

2. The electronic apparatus according to claim 1, wherein if the firmware detects that the firmware is started under the secure boot, the firmware performs runtime integrity check.

3. The electronic apparatus according to claim 2, wherein in an initial boot after the specific hardware module is installed to the electronic apparatus, the bootloader performs the normal boot without the argument;
in the initial boot after the specific hardware module is installed to the electronic apparatus, the firmware (a) initializes the specific hardware module, and (b) restarts the electronic apparatus;
in a second or later boot after the specific hardware module is installed to the electronic apparatus, the bootloader performs the secure boot with the argument; and
in the second or later boot after the specific hardware module is installed to the electronic apparatus, the firmware (a) on the basis of the argument, detects that the firmware is started under the secure boot, and (b) if the firmware detects that the firmware is started under the secure boot, performs the runtime integrity check.

4. The electronic apparatus according to claim 1, wherein the specific hardware module is a trusted platform module.
